(19) United States
(12) Patent Application Publication
(10) Pub. No.: US 2011/0035223 A1
(43) Pub. Date: Feb. 10, 2011

(54) AUDIO CLIPS FOR ANNOUNCING REMOTELY ACCESSED MEDIA ITEMS

(75) Inventor: Jon Schiller, San Ramon, CA (US)

Correspondence Address: KRAMER LEVIN NAFTALIS & FRANKEL LLP, 1177 Avenue of the Americas, New York, NY, 10036, US

(73) Assignee: Apple Inc., Cupertino, CA (US)

(21) Appl. No.: 12/534,985

(22) Filed: Aug. 4, 2009

(51) Int. Cl. G10L 13/08; G06F 3/01; G06F 15/16

(52) U.S. Cl. 704/260; 715/716; 709/231; 704/E13.001

(57) ABSTRACT

Systems and methods for retrieving and playing back audio clips for streamed or remotely received media items are provided. An electronic device can provide audio clips identifying media items at any suitable time, including for example to identify media items that are currently played back or available for playback. When the media items played back are not locally stored, the electronic device may not have a corresponding audio clip locally stored. In such cases, the electronic device can identify a streamed media item, and retrieve an audio clip corresponding to text items associated with the media item. For example, the electronic device can retrieve audio clips corresponding to the artist, title and album of the received media item. The electronic device can retrieve audio clips from any suitable source, such as a dedicated audio clip server or other remote source, a remote text-to-speech engine, or a locally stored text-to-speech engine.

### FIELD OF THE INVENTION

This relates to retrieving audio clips for announcing media items played back from a remote source. In particular, this relates to retrieving and playing back audio clips corresponding to text items identifying a media item for media items played back by an electronic device that are not locally stored by the device (e.g., for announcing streamed radio).

### BACKGROUND OF THE DISCLOSURE

Today, many popular electronic devices, such as personal digital assistants (“PDAs”) and hand-held media players or portable electronic devices (“PEDs”), are battery powered and include various user interface components. Conventionally, such portable electronic devices include buttons, dials, or touchpads to control the media devices and to allow users to navigate through media assets, including, for example, music, speech, or other audio, movies, photographs, interactive art, text, and media resident on (or accessible through) the media devices, to select media assets to be played or displayed, and/or to set user preferences for use by the media devices. The functionality supported by such portable electronic devices is increasing. At the same time, these media devices continue to get smaller and more portable. Consequently, as such devices get smaller while supporting robust functionality, there are increasing difficulties in providing adequate user interfaces for the portable electronic devices.

Some user interfaces have taken the form of graphical user interfaces or displays which, when coupled with other interface components on the device, allow users to navigate and select media assets and/or set user preferences. However, such graphical user interfaces or displays may be inconvenient, small, or unusable. Other devices have completely done away with a graphical user display. To enhance a user's ability to interact with such devices, the devices can provide audio clips describing operations performed by the device, the status of the device, or other suitable information. The audio clips can be generated using any suitable approach, including for example a text-to-speech engine or pre-recorded strings by human voices.

Typically, a device may have a single audio clip for each operation, instruction or media item of the device. In some embodiments, the device can include an audio clip of an artist name, song title, and album name, for example generated using a text to speech engine, or pre-recorded by an actor. The electronic device, however, may only locally store audio clips for media items that the device knows will be played back, for example locally stored media items.

### SUMMARY OF THE DISCLOSURE

This is directed to retrieving and playing back audio clips for media items played back by an electronic device, but that are not locally stored by the device. In particular, this is directed to providing audio clips for voice feedback for media items that the electronic device may not know will be played back when information is stored by the device (e.g., when the devices synchs with a host device).

An electronic device can provide audio clips identifying media items at any suitable time. For example, the electronic device can identify media items that are currently played back, were recently played back, or are scheduled for playback in the future. Similarly, the electronic device can identify playlists of media items that are played back or available for playback by the device. When the media items played back are locally stored, the electronic device can know the identity of the media items available for playback, and can then retrieve or generate audio clips for those known media items. For example, the electronic device can receive and locally store both available media items and their associated audio clips from a host device.

In some cases, however, a user can play back media items that are not locally stored. For example, the electronic device can connect to a remote server and stream media items. As another example, the user can remotely connect to a host device or other device (e.g., the user's home computer) to select particular media items to play back locally. The remote sources of media items, however, may not have audio clips available for the media items being streamed. Furthermore, even if audio clips are available from the same source, the audio clips may not be embedded in the audio stream, since the audio clips are played back in response to a user instruction.

To provide audio feedback for media items that are streamed from remote sources, the electronic device can first receive identifying information from the remote source. Alternatively, the electronic device can identify media items by reviewing metadata associated with each media item of the received stream. Once the media item has been identified, the electronic device can retrieve an audio clip corresponding to text items associated with the media item. For example, the electronic device can retrieve audio clips corresponding to the artist, title and album of the received media item.

The electronic device can retrieve audio clips from any suitable source. In some embodiments, the electronic device can connect to an audio clip server or other remote source for providing audio clips and request an audio clip for the identified media item. Instead or in addition, the electronic device can generate audio clips using a text-to-speech engine locally stored by the device. For example, the electronic device can apply a text-to-speech engine to text items related to the identified media items to generate audio clips for announcing the media items.

### BRIEF DESCRIPTION OF THE DRAWINGS

The above and other embodiments of the invention will be apparent upon consideration of the following detailed description, taken in conjunction with accompanying drawings, in which like reference characters refer to like parts throughout, and in which:

FIG. 1 is a schematic view of an illustrative electronic device for playing back audio clips in accordance with one embodiment of the invention;

FIG. 2 is a schematic view of an illustrative system for receiving media items for playback in accordance with one embodiment of the invention;

FIG. 3 is a schematic view of an illustrative system for providing and receiving radio broadcasts in accordance with one embodiment of the invention;

FIG. 4 is a flowchart of an illustrative process for retrieving and playing back an audio clip for a media item that is not locally stored by the device in accordance with one embodiment of the invention; and

FIG. 5 is a flowchart of an illustrative process for retrieving an audio clip in accordance with one embodiment of the invention.

### DETAILED DESCRIPTION OF THE DISCLOSURE

This relates to systems and methods for retrieving audio clips announcing media items that are streamed to an electronic device. In particular, this is directed to retrieving audio clips for announcing media items that are played back from a remote source.

Using an electronic device, a user may wish to announce media items being played back, or media items available for playback. In particular, a user of a device having no display or a limited display may require an audio announcement to identify media items available for playback. The electronic device can retrieve audio clips for announcing media items from any suitable source. In some embodiments, the electronic device can locally store audio clips for locally stored media items when the media items are received from a host device. This can ensure that appropriate audio clips are available for the locally stored media.

When media is instead streamed to the device, or received from a remote source, the electronic device may not have local access to audio clips for announcing the remotely received media items. The electronic device can then identify the received media items, and request and receive audio clips for the received media items from a remote source. In some embodiments, the electronic device can instead or in addition generate audio clips from text items associated with the received media items (e.g., text items determined from metadata associated with the received items) using a text-to-speech engine locally stored on the electronic device.

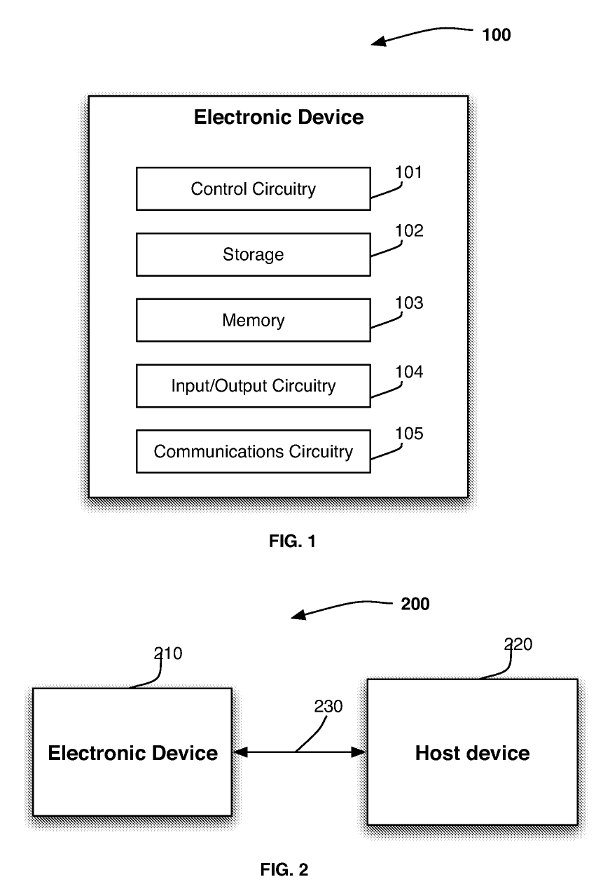

FIG. 1 is a schematic view of an illustrative electronic device for playing back audio clips in accordance with one embodiment of the invention. Electronic device 100 can include control circuitry 101, storage 102, memory 103, input/output circuitry 104, and communications circuitry 105. In some embodiments, one or more of the components of electronic device 100 can be combined or omitted. For example, storage 102 and memory 103 can be combined into a single mechanism for storing data. In some embodiments, electronic device 100 can include other components not combined or included in those shown in FIG. 1, such as a power supply (e.g., a battery or kinetics), a display, a bus, or an input interface. In some embodiments, electronic device 100 can include several instances of the components shown in FIG. 1 but, for the sake of simplicity, only one of each of the components is shown in FIG. 1.

Electronic device 100 can include any suitable type of electronic device operative to provide music. For example, electronic device 100 can include a media player such as an iPod® available by Apple Inc., of Cupertino, Calif., a cellular telephone, a personal e-mail or messaging device, an iPhone® available from Apple Inc., pocket-sized personal computers, personal digital assistants (PDAs), a laptop computer, a music recorder, a video recorder, a camera, and any other suitable electronic device. In some cases, electronic device 100 can perform a single function (e.g., a device dedicated to playing music) and in other cases, electronic device 100 can perform multiple functions (e.g., a device that plays music, displays video, stores pictures, and receives and transmits telephone calls).

Control circuitry 101 can include any processing circuitry or processor operative to control the operations and performance of an electronic device of the type of electronic device 100. Storage 102 and memory 103, which can be combined can include, for example, one or more storage mediums or memory used in an electronic device of the type of electronic device 100. In particular, storage 102 and memory 103 can store information related to monitoring an environment such as signals received from a sensor or another device or a characteristic property of the environment derived from a received signal. Input/output circuitry 104 can be operative to convert (and encode/decode, if necessary) analog signals and other signals into digital data, for example in any manner typical of an electronic device of the type of electronic device 100. Electronic device 100 can include any suitable mechanism or component for allowing a user to provide inputs to input/output circuitry 104, and any suitable circuitry for providing outputs to a user (e.g., audio output circuitry or display circuitry).

Communications circuitry 105 can include any suitable communications circuitry operative to connect to a communications network and to transmit communications (e.g., voice or data) from device 100 to other devices within the communications network. Communications circuitry 105 can be operative to interface with the communications network using any suitable communications protocol such as, for example, Wi-Fi (e.g., a 802.11 protocol), Bluetooth®, radio frequency systems (e.g., 900 MHz, 1.4 GHz, and 5.6 GHz communication systems), cellular networks (e.g., GSM, AMPS, GPRS, CDMA, EV-DO, EDGE, 3GSM, DECT, IS-136/TDMA, iDen, LTE or any other suitable cellular network or protocol), infrared, TCP/IP (e.g., any of the protocols used in each of the TCP/IP layers), HTTP, FTP, RTP, RTSP, SSH, Voice over IP (VOIP), any other communications protocol, or any combination thereof. In some embodiments, communications circuitry 105 can be operative to provide wired communications paths for electronic device 100.

In some embodiments, communications circuitry 105 can interface electronic device 100 with an external device or sensor for monitoring an environment. For example, communications circuitry 105 can interface electronic device 100 with a network of cameras for monitoring an environment. In another example, communications circuitry 105 can interface electronic device 100 with a motion sensor attached to or incorporated within a user's body or clothing (e.g., a motion sensor similar to the sensor from the Nike+iPod Sport Kit sold by Apple Inc. of Cupertino, Calif. and Nike Inc. of Beaverton, Oreg.).

FIG. 2 is a schematic view of an illustrative system for receiving media items for playback in accordance with one embodiment of the invention. System 200 can include electronic device 210 and host device 220. Electronic device 210 can include any suitable electronic device, including for example an electronic device having some or all of the features of electronic device 100 (FIG. 1). Host device 220 can include any suitable type of device operative to provide power, data (e.g., media files) or both to electronic device 210. For example, host device 220 may include a computer (e.g., a desktop or laptop computer), a server (e.g., a server available over the Internet or using a dedicated communications link), a kiosk, or any other suitable device. In some embodiments, host device 230 can include a remote server, for example accessible over the Internet. Host device 220 can include any suitable communications circuitry for communication with electronic device over communications path 230.

Communications path 230 can be provided by any suitable communications circuitry operative to connect to a communications network and to transmit communications (e.g., voice or data) from electronic device 210 to host device 220, or other devices within a communications network. Communications path 230 can support any suitable communications protocol such as, for example, Wi-Fi (e.g., a 802.11 protocol), Bluetooth (registered trademark), radio frequency systems (e.g., 900 MHz, 1.4 GHz, and 5.6 GHz communication systems), infrared, GSM, GSM plus EDGE, CDMA, quadband, and other cellular protocols, VOIP, or any other suitable protocol. In some embodiments, communications path 230 may be operative to receive media or data over the Internet (e.g., streaming media or downloaded media).

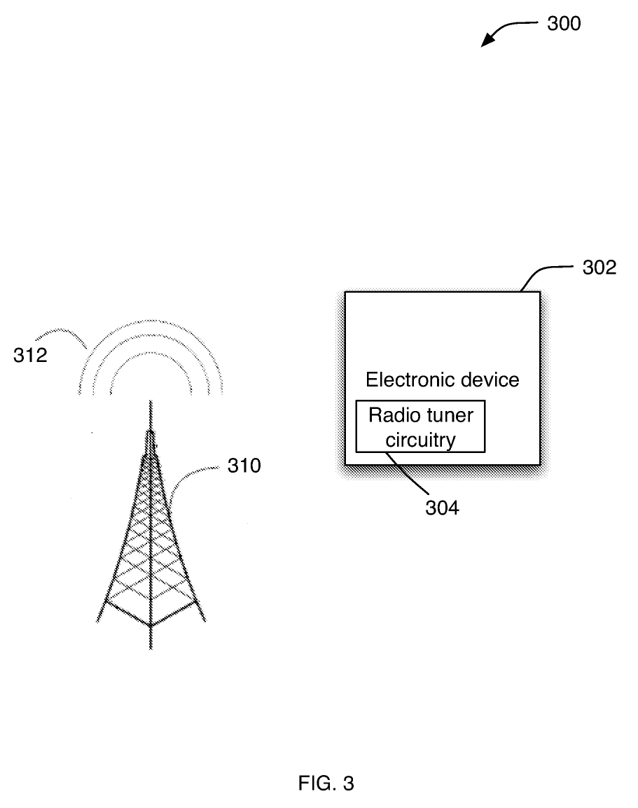

The electronic device can receive media streams from a variety of sources. In some embodiments, the electronic device can receive a radio stream. FIG. 3 is a schematic view of an illustrative system for providing and receiving radio broadcasts in accordance with one embodiment of the invention. System 300 can include one or more electronic devices 302 operative to receive radio station broadcasts, although only one is shown in FIG. 3 for simplicity. Each electronic device 302 can include radio tuner circuitry 304 operative to tune to and receive a radio broadcast. Radio station 310 can provide broadcast 312 of media using, for example, a AM or FM radio signal, for any electronic device 302 within the broadcast range of radio station 310. In addition to the media, radio station 310 can broadcast radio station information such as Radio Data System (RDS) information. RDS information can include, for example, digital information such as station identification, the current song's track, artist, genre, and length information, and/or alternative frequencies for particular stations.

In some embodiments, the electronic device can receive a media stream from a remote server over other communications paths, such as over the Internet. For example, the electronic device can receive a media stream broadcast over the Internet by a radio station. As another example, the electronic device can receive a personalized media stream from a remote server (e.g., a personalized radio station streamed over the Internet, for example Pandora Internet radio, available from Pandora Media Inc. of Oakland, Calif.).

The electronic device can play back audio clips at any appropriate time. For example, the electronic device can play back audio clips announcing or identifying media items available for playback, or electronic device operations to be performed. The audio clips can correspond to content or text items, such that the audio clips can serve as a spoken menu or sufficiently identify content for a user. Audio clips can be played back at any suitable time, including for example automatically when the media item played back changes, when a particular event is detected by the electronic device (e.g., battery power is less than a minimum threshold), in response to performing a particular electronic device operation (e.g., skipping to the next song), or any other event that the electronic device can detect. In some embodiments, the electronic device can play back audio clips for providing feedback in response to a user instruction (e.g., the user provides a request using an input interface to announce an audio clip).

The audio clips can include any suitable content. In some embodiments, the audio clips can correspond to a particular text item or content that relates to a media item. In particular, an audio clip can be generated for any information describing, identifying, or otherwise related to or associated with a media item available for playback by an electronic device. For example, an audio clip can correspond to text identifying an artist, title and album of a media item. Audio clips can be generated using any suitable approach, including for example from some or all of the metadata that is associated with a media item or a collection of media items (e.g., an album, series, or collection). For example, audio clips can be generated based on the artist, album, title, composer, time, genre, year, rating, description, grouping, compilation, playlist, beats per minute (BPM), comments, play count, codec, lyrics, show, or any other metadata field. In some embodiments, audio clips may be generated for text items that relate to media items but are not metadata associated with the media items.

At an appropriate time (e.g., automatically or in response to a user input), the electronic device can identify and play back an appropriate audio clip to play back. For example, the electronic device can identify a particular media item for which identifying information is necessary, and play back an audio clip identifying the media item. When the media item is locally stored, the electronic device can also have locally stored the audio clip corresponding to the media item. In particular, a host device providing the media item to the electronic device can also provide the audio clip to the device. When the media item being played back, however, is not locally stored (e.g., a streamed media item), the electronic device may not have an audio clip corresponding to the media item.

The electronic device can retrieve an appropriate audio clip for a media item using any suitable approach. First, the electronic device can identify the particular media item so as to know which audio clip will be required. The electronic device can identify a received media item using any suitable approach. For example, the electronic device can monitor each the broadcast stream or broadcast source (e.g., a radio station) and retrieve data describing each broadcast media item from the broadcast stream (e.g., identified from metadata broadcast with the media, such as RDS, RT or RT+ data). As another example, the electronic device can access a remote database that includes a listing of the media items broadcast or to be broadcast by particular media sources, and cross-reference the current time with the media sources to identify a currently received (or received at another time) media item. The remote database can be provided by individual media sources, or generated and managed by a specialized entity. As still another example, the electronic device can identify media items by analyzing the received audio to detect characteristic chord progressions, lyrics, or other unique attributes of the media item.

Once the media item for which the audio clip is to be played back has been identified, the electronic device can retrieve the particular audio clip corresponding to the identified media item. The electronic device can retrieve audio clips identifying media items from any suitable source. In some embodiments, the electronic device can connect to a dedicated source of audio clips. For example, the electronic device can connect to a media server (e.g., the iTunes music store, available from Apple Inc.) In some embodiments, the electronic device can instead or in addition request audio clips from the source of the media items (e.g., from the remote source providing the media stream). In some embodiments, the electronic device can receive audio clips generated by a dedicated text-to-speech engine that creates audio clips from text items corresponding to the identified media item. If the engine does not have an audio clip already generated for a particular item, the electronic device can provide the text item corresponding to the media item to the text-to-speech engine to have a new audio clip generated.

In some embodiments, the electronic device can have a text-to-speech engine included as part of the circuitry or code of the device. In such cases, the electronic device can direct the local text-to-speech engine to generate audio clips from text items corresponding to the identified media item. For example, the electronic device can generate an audio clip from text items extracted from metadata associated with the identified media item. The electronic device can then play back the generated audio clips for the identified media items.

The electronic device can retrieve audio clips at any suitable time. In some embodiments, the electronic device can retrieve audio clips each time a new media item is played back. This can ensure that the lag detected by the user when an instruction to play back an audio clip is received is minimized. In particular, because audio clips are automatically requested and retrieved, the electronic device can have the audio clips accessible upon request. To limit the space required in storage or memory for audio clips, the electronic device can store the audio clips in a buffer, and replace older audio clips with newer audio clips.

Alternatively, the electronic device can only retrieve audio clips in response to receiving an instruction to play back an audio clip. This can help reduce the power and data consumption of the electronic device, as the communications circuitry may not be subject to more limited use. The audio clip playback, however, may be subject to lag as there may be a delay during which the audio clip is downloaded or streamed.

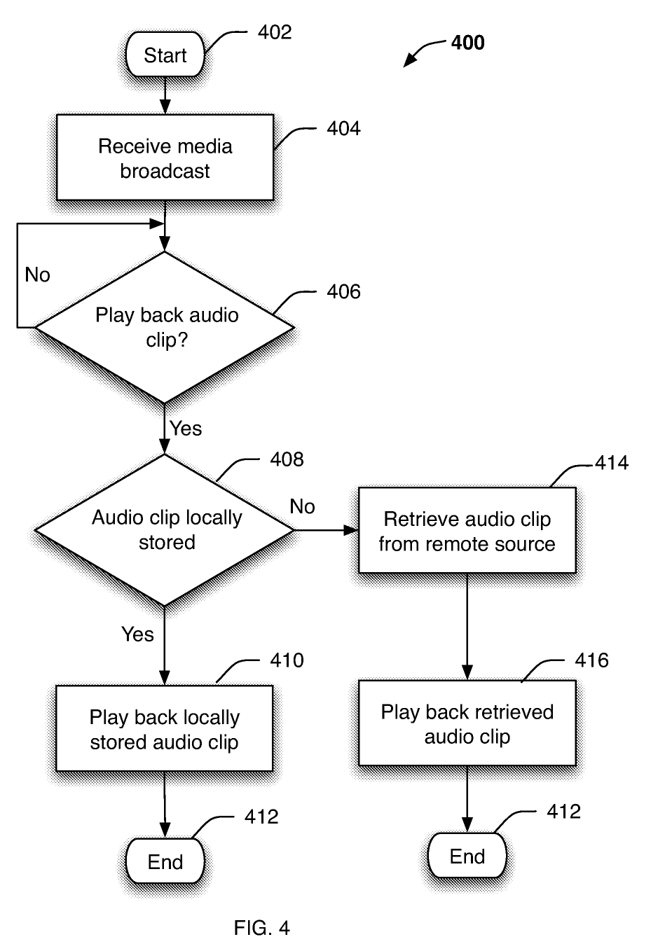

The following flowcharts describe illustrative methods used for retrieving audio clips for playback. FIG. 4 is a flowchart of an illustrative process for retrieving and playing back an audio clip for a media item that is not locally stored by the device in accordance with one embodiment of the invention. Process 400 can begin at step 402. At step 404, the electronic device can receive a media broadcast. For example, the electronic device can receive a broadcast transmitted by a radio station. As another example, the electronic device can receive a media stream transmitted over the Internet. At step 406, the electronic device can determine whether to play back an audio clip. For example, the electronic device can determine whether an instruction to play back an audio clip was received (e.g., from an input provided by the user to an input interface). As another example, the electronic device can determine whether a condition was met in response to which an audio clip is to be played back. If the electronic device determines that no audio clip is to be played back, process 400 can return to step 406 and continue to monitor for events associated with playing back an audio clip. In some embodiments, the electronic device can instead or in addition retrieve an audio clip for an identified media item even in the absence of a specific instruction to play back the audio clip.

If, at step 406, the electronic device instead determines that an audio clip is to be played back, process 400 can move to step 408. At step 408, the electronic device can determine whether the audio clip to play back is locally stored. For example, the electronic device can determine whether the audio clip corresponds to a media item that is locally stored (e.g., that was provided by a host device to which the electronic device was connected). If the electronic device determines that the audio clip to play back is locally stored, process 400 can move to step 410 and play back the locally stored audio clip. For example, the electronic device can play back a locally stored audio clip identifying a media item (e.g., an audio clip of a media item artist, title and album). Process 400 can then end at step 412.

If, at step 408, the electronic device instead determines that the audio clip was not locally stored, process 400 can move to step 414. At step 414, the electronic device can retrieve the audio clip to play back from a remote source. For example, the electronic device can provide a specific request to a remote server identifying the audio clip required (e.g., identifying the media item for which the audio clip is required). As another example, the electronic device can provide a text item or content to a remote server to request that an audio clip be generated using a text-to=speech engine. The generated audio clip can then be transmitted to the electronic device for playback. At step 416, the electronic device can play back the retrieved audio clip. Process 400 can then end at step 412.

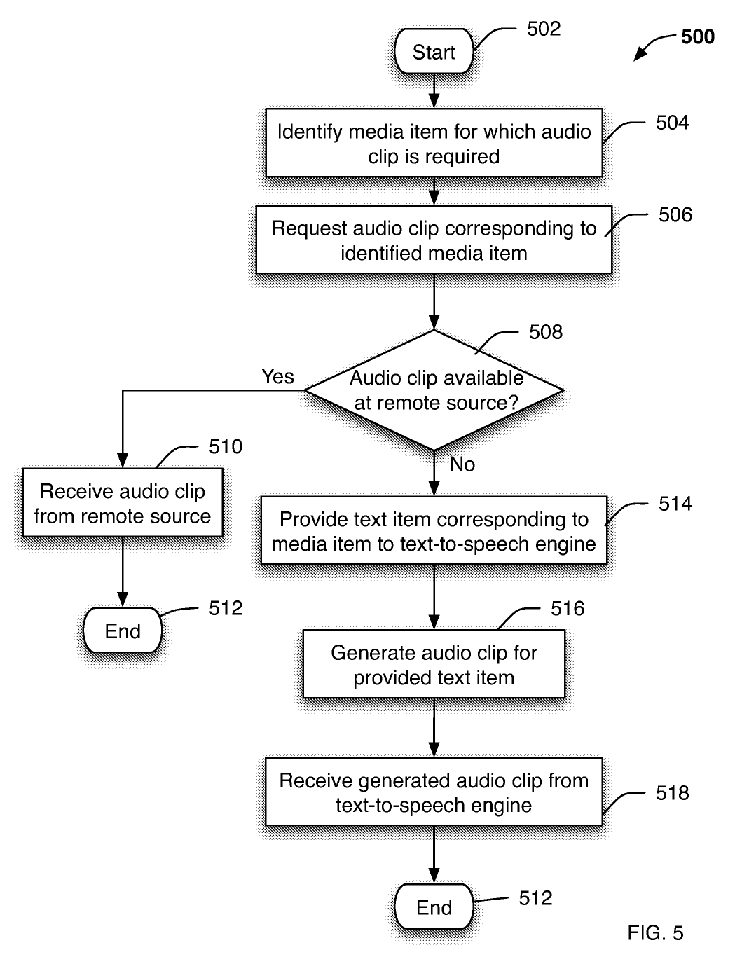

FIG. 5 is a flowchart of an illustrative process for retrieving an audio clip in accordance with one embodiment of the invention. Process 500 can begin at step 502 which can correspond, in some embodiments, to step 414 of process 400 (FIG. 4) At step 504, the electronic device can identify a media item for which an audio clip is required. For example, the electronic device can identify the currently played back media item. The electronic device can identify a media item using any suitable approach, including for example based on an audio analysis of the audio clip or from metadata associated with the audio clip and received from a remote source. At step 506, the electronic device can request an audio clip corresponding to the identified media item from a remote source. For example, the electronic device can request an audio clip from a dedicated server. As another example, the electronic device can request an audio clip from the source of the identified media item. At step 508, the electronic device can determine whether the audio clip is available from the remote source. For example, the electronic device can receive an indication from the remote source. As another example, the electronic device can review a listing of available audio clips provided by the remote source. If the electronic device determines that the audio clip is available from the remote source, process 500 can move to step 510.

At step 510, the electronic device can receive an audio clip corresponding to the identified media item from the remote source. For example, the electronic device can receive a previously recorded or generated audio clip from the remote source. Process 500 can then end at step 512. If, at step 508, the electronic device instead determines that the audio clip is not available from the remote source, process 500 can move to step 514. At step 514, the electronic device can provide a text item corresponding to the identified media item to a text-to-speech engine. For example, the electronic device can provide metadata text strings identifying the media item to a text-to-speech engine. The text item can include any suitable text, including for example the artist, title and album of the media item. The text-to-speech engine can be located at a remote server, or locally stored on the electronic device. At step 516, the text-to-speech engine can generate an audio clip for the provided text item. For example, the text-to-speech engine can apply phonemes to the text to generate audio speaking the text item. At step 518, the electronic device can receive the generated audio clip from the text-to-speech engine. For example, the electronic device can receive a transmission of the generated audio clip from a remote server. Process 500 can then end at step 512.

Although many of the embodiments of the present invention are described herein with respect to personal computing devices, it should be understood that the present invention is not limited to personal computing applications, but is generally applicable to other applications.

The invention is preferably implemented by software, but can also be implemented in hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, and optical data storage devices. The computer readable medium can also be distributed over network-coupled computer systems so that the computer readable code is stored and executed in a distributed fashion.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The above-described embodiments of the present invention are presented for purposes of illustration and not of limitation, and the present invention is limited only by the claims which follow.

What is claimed is:

1. A method for playing back an audio clip corresponding to a streamed media item, comprising:
streaming a remotely accessed media item for playback;
identifying the streamed media item;
retrieving an audio clip corresponding to the identified media item, wherein the audio clip is associated with content announcing the media item; and
playing back the retrieved audio clip.

2. The method of claim 1, further comprising:
providing identification information for the media item to a remote server; and
requesting the audio clip from the remote server.

3. The method of claim 2, further comprising:
retrieving the audio clip associated with the provided identification information.

4. The method of claim 1, wherein identifying further comprises at least one of:
reviewing metadata received with the streamed media item; and
analyzing the audio of the media item.

5. The method of claim 1, wherein the audio clip is associated with a text item.

6. The method of claim 5, wherein the text item comprises at least one of:
album;
composer;
tv show;
movie;
series;
duration;
genre;
year;
rating;
description;
playlist;
compilation;
beats per minute;
comments;
play count;
codec; and
lyrics.

7. The method of claim 1, further comprising:
providing a text item associated with the streamed media item to a text-to-speech engine; and
receiving an audio clip generated from the text-to-speech engine, wherein the audio clip corresponds to the provided text item.

8. The method of claim 7, wherein:
the text-to-speech engine is located at a remote source.

9. The method of claim 7, wherein:
the text-to-speech engine is located at a device streaming the remotely accessed media item.

10. An electronic device for playing back audio clips, comprising audio output circuitry, communications circuitry, and control circuitry, the control circuitry operative to:
direct the communications circuitry to receive a media item from a remote source;
direct the audio output circuitry to play back the received media item;
direct the communications device to request an audio clip corresponding to the received media item; and
direct the audio output circuitry to play back the requested audio clip.

11. The electronic device of claim 10, wherein the control circuitry is further operative to:
identify the received media item; and
identify an audio clip associated with the received media item.

12. The electronic device of claim 11, wherein the control circuitry is further operative to:
direct the communications circuitry to receive metadata from the remote source; and
identify the received media item from the received metadata.

13. The electronic device of claim 10, wherein the control circuitry is further operative to:
identify the received media item;
direct the communications circuitry to provide the identifying information of the media item to a remote source; and
direct the communications circuitry to receive, from the remote source, the audio clip corresponding to the identifying information.

14. The electronic device of claim 10, wherein:
the audio clip corresponds to a text item, the text item comprising metadata associated with the media item.

15. The electronic device of claim 14, wherein the audio clip comprises:
audio corresponding to speaking at least one of a title, artist and album of the received media item.

16. A server for providing audio clips announcing media items, comprising control circuitry and communications circuitry, the control circuitry operative to:
direct the communications circuitry to stream a media item to an electronic device;
receive a request from the electronic device for an audio clip announcing the streamed media item; and
retrieve the audio clip;
direct the communications circuitry to provide the retrieved audio clip to the electronic device.

17. The server of claim 16, wherein the control circuitry is further operative to:
receive identifying information identifying a particular media item for which an audio clip is requested.

18. The server of claim 17, wherein the control circuitry is further operative to:
identify an audio clip associated with the identified media item; and
retrieve the identified audio clip.

19. The server of claim 16, wherein the control circuitry is further operative to:
determine that the identified audio clip is not available;
retrieve a text item corresponding to the audio clip; and
generate an audio clip from the text item using a text-to-speech engine.

20. The server of claim 18, wherein the control circuitry is further operative to:
identify metadata associated with the media item; and
extract a text item from the identified metadata.

21. Computer readable media for playing back an audio clip corresponding to a streamed media item, the computer readable media comprising computer readable instructions recorded thereon for:
streaming a remotely accessed media item for playback;
identifying the streamed media item;
retrieving an audio clip corresponding to the identified media item, wherein the audio clip is associated with content announcing the media item; and
playing back the retrieved audio clip.

22. The computer readable media of claim 21, further comprising additional computer readable instructions recorded thereon for:
providing identification information for the media item to a remote server; and requesting the audio clip from the remote server.
